(19) United States
(12) Patent Application Publication
(10) Pub. No.: US 2018/0039952 A1
(43) Pub. Date: Feb. 8, 2018

(54) SYSTEM FOR DATA EXTRACTION AND GENERATING NOTIFICATIONS FOR USER COORDINATION

(71) Applicant: BANK OF AMERICA CORPORATION, Charlotte, NC (US)

(72) Inventors: Katherine Dintenfass, Lincoln, RI (US); Victoria L. Dravneek, Charlotte, NC (US); Matthew Hsieh, Charlotte, NC (US); Wade Travis Hobbs, Mooresville, NC (US)

(21) Appl. No.: 15/296,835

(22) Filed: Oct. 18, 2016

Related U.S. Application Data
(60) Provisional application No. 62/372,044, filed on Aug. 8, 2016.

(51) Int. Cl. G06Q 10/10; H04L 29/08; G06F 17/30

(52) U.S. Cl. CPC G06Q 10/1095; G06F 17/3051; G06F 17/30867; H04L 67/10

(57) ABSTRACT

Embodiments of the invention are directed to a system, method, or computer program product for identifying and generating actionable notifications for user coordination. The invention establishes a communication link to one or more user devices over a distributed network in order to continuously monitor and extract user information such as financial data, device data, calendar data, and social data. In this way, the invention may identify social and financial user trends as well as scheduled events such as meetings, appointments, deadlines, and the like. The invention transmits actionable notifications to the user device allowing the invention to act upon the user response. Additionally, the invention may communicate with third party systems to offer third party products and services to the user.

### CROSS-REFERENCE OF RELATED APPLICATIONS

This application claims priority to U.S. Provisional Patent Application Ser. No. 62/372,044, filed Aug. 8, 2016, entitled “SYSTEM FOR DATA EXTRACTION AND GENERATING NOTIFICATIONS FOR USER COORDINATION,” the entirety of which is incorporated herein by reference.

### BACKGROUND

While calendar applications installed on computing devices organize events input by a user, there exists a need to notify the user of scheduled items as well as to extract and identify additional, complimentary information, such as a product or service, which may benefit a user, such as a small business owner.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing an innovative system, method, and computer program product for a data extraction and notification system allowing users, such as small business owners, to coordinate personal schedules, business operations, and employees.

In some embodiments, the system may learn about small businesses and their owners in order to deepen an entity relationship with the small business. For example, by providing third party products/services to the small business. The invention may provide necessary notifications from the small business to its employees including reminders for personal tasks to be completed such as “sign up for health plan”, “make IRA contributions” or to enable benefits such as a concierge service for dry cleaning or the like to the employees. The invention may use employee aggregation to negotiate certain benefits for the employees such as sharing rides or the like. The application could also provide business-related notifications to the employees such as providing low inventory alerts, providing sales or marketing leads to relevant employees, etc. The invention can also use the company electronic calendaring to push notifications to coordinate deadlines such as by providing checklists.

Embodiments of the invention relate to systems, methods, and computer program product for identifying and generating actionable notifications for user coordination, the invention comprising: establishing, via the distributed network, an operative communication channel with a user device associated with a user, wherein the operative communication channel allows for real-time communication with the user device; continuously monitoring and extracting user information from the user device via the operative communication channel, wherein extracted user information comprises financial data, device data, calendar data, and social data; generating a database containing the extracted user information; identifying one or more trends and trigger events associated with the user, the one or more trigger events comprising a deadline, a scheduled event, or an alert; triggering transmission of an actionable notification to the user device, wherein the actionable notification is associated with the one or more trends and trigger events; receiving a user response associated with the actionable notification; and initiating one or more response actions based on the received user response.

In some embodiments, establishing the operative communication channel with the user device further comprises establishing an operative communication channel with a third party system, wherein third party products and services are provided to the user based on the user information extracted from the user device.

In some embodiments, initiating one or more response actions based on the received user response further comprises updating a calendar on the user device with the one or more trigger events based on receiving a confirmation in the user response associated with the actionable notification.

In some embodiments, initiating one or more response actions based on the received user response further comprises generating a checklist of scheduled events and actions for the user to complete in order to meet a scheduled deadline.

In some embodiments, continuously monitoring and extracting user information from the user device via the operative communication channel further comprises monitoring a number of an item in an inventory and transmitting an actionable notification to the user device based on determining that the number of an item in the inventory has fallen below a predetermined threshold.

In some embodiments, identifying the one or more trends and trigger events associated with the user further comprises determining purchasing trends associated with the user from the financial data stored on the user device and/or a financial institution associated with the user.

In some embodiments, identifying the one or more trends and trigger events associated with the user further comprises monitoring the user's internet browsing history, social media activity, and frequently used applications on the user device.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a user coordination system environment, in accordance with one embodiment of the present invention;

FIG. 2 provides a high level process flow for identifying and generating actionable notifications for small business operations, in accordance with one embodiment of the invention; and

FIG. 3 provides a high level process flow for identifying and generating actionable notifications for providing third party products and/or services, in accordance with one embodiment of the invention.

### DETAILED DESCRIPTION OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

An “account” is the relationship that a user has with an entity, such as a financial institution. Examples of accounts include a deposit account, such as a transactional account (e.g., a banking account), a savings account, an investment account, a money market account, a time deposit, a demand deposit, a pre-paid account, a credit account, a non-monetary user profile that includes information associated with the user, or the like. The account is associated with and/or maintained by the entity. “Assets” include accounts of the user and/or other property owned by the user. The assets may be associated with accounts or may be property that is not associated with a specific account. Examples of assets associated with accounts may be accounts that have cash or cash equivalents, or accounts that are funded with or contain property, such as safety despots box account that jewelry, a trust account that is funded with property, or the like. Examples of assets that may not be associated with accounts may be antiques in a user's home, jewelry in a user's home, or the like. “Authentication information” is any information that can be used to identify of a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. An “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. A “financial event” or “life event” may be any immediate or future event that causes a change in a user's financial status. A financial event may be a charge, a transaction, and exchange, or the like that may cause the user to lose or gain money and/or assets. Examples of financial events or life events include a medical expense, buying a house, college tuition, rent, and the like.

To “monitor” is to watch, observe, or check something for a special purpose over a period of time. The “monitoring” may occur periodically over the period of time, or the monitoring may occur continuously over the period of time. In some embodiments, a system may actively monitor a database, wherein the system reaches out to the database and watches, observes, or checks the database for changes, updates, and the like. In other embodiments, a system may passively monitor a database, wherein the database provides information to the system and the system then watches, observes, or checks the provided information. A “transaction” refers to any communication between a user and the financial institution or other entity monitoring the user's activities. For example, a transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like. A “user” may be a financial institution customer (e.g., an account holder or a person who have an account (e.g., banking account, credit account, or the like)). In one aspect, a user may be any financial institution customer who is an owner or employee of a small business. In some embodiments, a “user” may be a financial institution employee (e.g., an underwriter, a project manager, an IT specialist, a manager, an administrator, an internal operations analyst, bank teller or the like) capable of operating the system described herein. For purposes of this invention, the term “user” and “customer” may be used interchangeably. A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users. Finally, the terms house, home, or property may refer to one or more real-estate or parcels of land.

Furthermore, as used herein the term “user device” may refer to any device that employs a processor and memory and can perform computing functions, such as a personal computer or a mobile device, wherein a mobile device is any mobile communication device, such as a cellular telecommunications device (i.e., a cell phone or mobile phone), personal digital assistant (PDA), a mobile Internet accessing device, or other mobile device. Other types of mobile devices may include portable digital assistants (PDAs), pagers, wearable devices, mobile televisions, gaming devices, laptop computers, cameras, video recorders, audio/video player, radio, GPS devices, or any combination of the aforementioned.

In some embodiments, the system may learn about small businesses and their owners in order to deepen an entity relationship with the small business. For example, by providing third party products/services to the small business. The invention may provide necessary notifications from the small business to its employees including reminders for personal tasks to be completed such as “sign up for health plan”, “make IRA contributions” or to enable benefits such as a concierge service for dry cleaning or the like to the employees. The invention may use employee aggregation to negotiate certain benefits for the employees such as sharing rides or the like. The application could also provide business-related notifications to the employees such as providing low inventory alerts, providing sales or marketing leads to relevant employees. The invention can also use the company electronic calendaring to push notifications to coordinate deadlines such as by providing checklists.

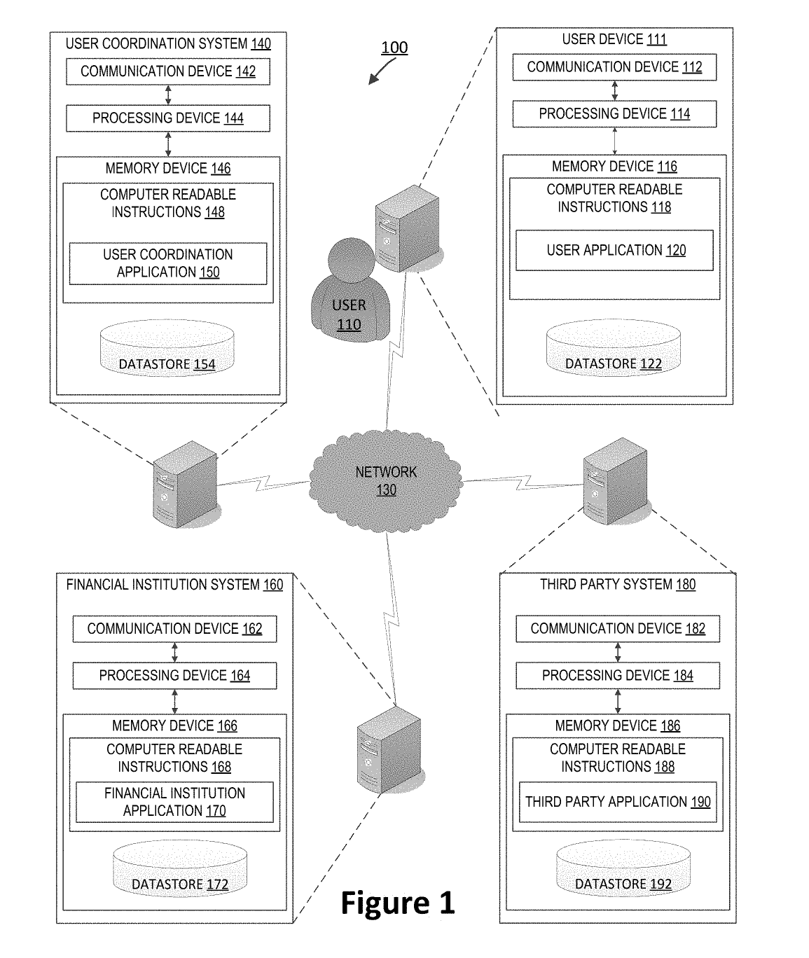

Referring to FIG. 1, the figure illustrates a user coordination system environment 100, in accordance with some embodiments of the invention. The environment 100 includes a user device 111 associated or used with authorization of a user 110 (e.g., a mobile application user, and the like), a user coordination system 140, one or more third party systems 180, and a financial institution system 160.

The systems and devices communicate with one another over the network 130 and perform one or more of the various steps and/or methods according to embodiments of the disclosure discussed herein. The network 130 may include a local area network (LAN), a wide area network (WAN), and/or a global area network (GAN). The network 130 may provide for wireline, wireless, or a combination of wireline and wireless communication between devices in the network. In one embodiment, the network 130 includes the Internet.

The user device 111, the third party system 180, the financial institution system 160 and the user coordination system 140 each includes a computer system, server, multiple computer systems and/or servers or the like. The user coordination system 140, in the embodiments shown has a communication device 142 communicably coupled with a processing device 144, which is also communicably coupled with a memory device 146. The processing device 144 is configured to control the communication device 142 such that the user coordination system 140 communicates across the network 130 with one or more other systems. The processing device 144 is also configured to access the memory device 146 in order to read the computer readable instructions 148, which in some embodiments includes a user coordination application 150. The user coordination application 150 allows for the user coordination system 140 to communicate to the various other systems and devices within the environment 100. The functions of the user coordination application 150 are further described in detail below. The memory device 146 also includes a datastore 154 or database for storing pieces of data that can be accessed by the processing device 144.

As used herein, a “processing device,” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 114, 144, 164, or 184 may further include functionality to operate one or more software programs based on computer-executable program code thereof, which may be stored in a memory. As the phrase is used herein, a processing device 114, 144, 164, or 184 may be “configured to” perform a certain function in a variety of ways, including, for example, by having one or more general-purpose circuits perform the function by executing particular computer-executable program code embodied in computer-readable medium, and/or by having one or more application-specific circuits perform the function.

Furthermore, as used herein, a “memory device” generally refers to a device or combination of devices that store one or more forms of computer-readable media and/or computer-executable program code/instructions. Computer-readable media is defined in greater detail below. For example, in one embodiment, the memory device 146 includes any computer memory that provides an actual or virtual space to temporarily or permanently store data and/or commands provided to the processing device 144 when it carries out its functions described herein.

The user device 111 includes a communication device 112 communicably coupled with a processing device 114, which is also communicably coupled with a memory device 116. In some embodiments, the communication device 112 may also comprise a GPS transceiver capable of determining a geographic location associated with the user device 111. The processing device 114 is configured to control the communication device 112 such that the user device 111 communicates across the network 130 with one or more other systems. The processing device 114 is also configured to access the memory device 116 in order to read the computer readable instructions 118, which in some embodiments includes a user application 120. The user application 120 allows for communication of the user device 111 with the other systems and devices within the environment 100 such as the user coordination system 140, third party system 180, and financial institution system 160. The user application 120 allows the user 111 to receive information transmitted as well as input information requested by the user coordination system 140 and communicate with the financial institution and one or more third parties. The memory device 116 also includes a datastore 122 or database for storing pieces of data that can be accessed by the processing device 114.

The third party system 180 includes a communication device 182 communicably coupled with a processing device 184, which is also communicably coupled with a memory device 186. The processing device 184 is configured to control the communication device 182 such that the third party system 180 communicates across the network 130 with one or more other systems. The processing device 184 is also configured to access the memory device 186 in order to read the computer readable instructions 188, which in some embodiments includes a third party application 190. The third party application 190 allows for communication with the other systems and devices within the environment 100 such as the user device 111, the user coordination system 140, and the financial institution system 160. The memory device 186 also includes a datastore 192 or database for storing pieces of data that can be accessed by the processing device 184.

The financial institution system 160 includes a communication device 162 communicably coupled with a processing device 164, which is also communicably coupled with a memory device 166. The processing device 164 is configured to control the communication device 162 such that the financial institution system 160 communicates across the network 130 with one or more other systems. The processing device 164 is also configured to access the memory device 166 in order to read the computer readable instructions 168, which in some embodiments includes a financial institution application 170. The financial institution application 170 allows for communication with the other systems and devices within the environment 100 such as the user device 111, the user coordination system 140, and the third party system 180. The memory device 166 also includes a datastore 172 or database for storing pieces of data that can be accessed by the processing device 164.

The user application 120, the user coordination application 150, the third party application 190, and the financial institution application 170 are for instructing the processing devices 114, 144, 184, and 164 respectively to perform various steps of the methods discussed herein, and/or other steps and/or similar steps. In various embodiments, one or more of the user application 120, the user coordination application 150, the third party application 190, and the financial institution application 170 are included in the computer readable instructions stored in a memory device of one or more systems or devices other than the third party system 180, the user coordination system 140, the user device 111, and the financial institution system 160. For example, in some embodiments, the user application 120 is stored and configured for being accessed by a processing device of the financial institution system 160 connected to the network 130. In various embodiments, the user application 120, the user coordination application 150, the third party application 190, and the financial institution application 170 are stored and executed by different systems/devices. In some embodiments, the user application 120, the user coordination application 150, the third party application 190, and the financial institution application 170 stored and executed by different systems may be similar and may be configured to communicate with one another. In some embodiments, the user application 120, the user coordination application 150, the third party application 190, and the financial institution application 170 may be considered to be working together as a singular application despite being stored and executed on different systems.

In various embodiments, one of the systems discussed above, such as the user coordination system 140, is more than one system and the various components of the system are not collocated, and in various embodiments, there are multiple components performing the functions indicated herein as a single device. For example, in one embodiment, multiple processing devices perform the functions of the processing device 144 of the user coordination system 140 described herein.

In various embodiments, the user coordination system 140, the third party system 180, the financial institution system 160 and the user device 111 and/or other systems may perform all or part of a one or more method steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of one or more of the method discussed herein, or other methods, processes or steps discussed herein or not discussed herein.

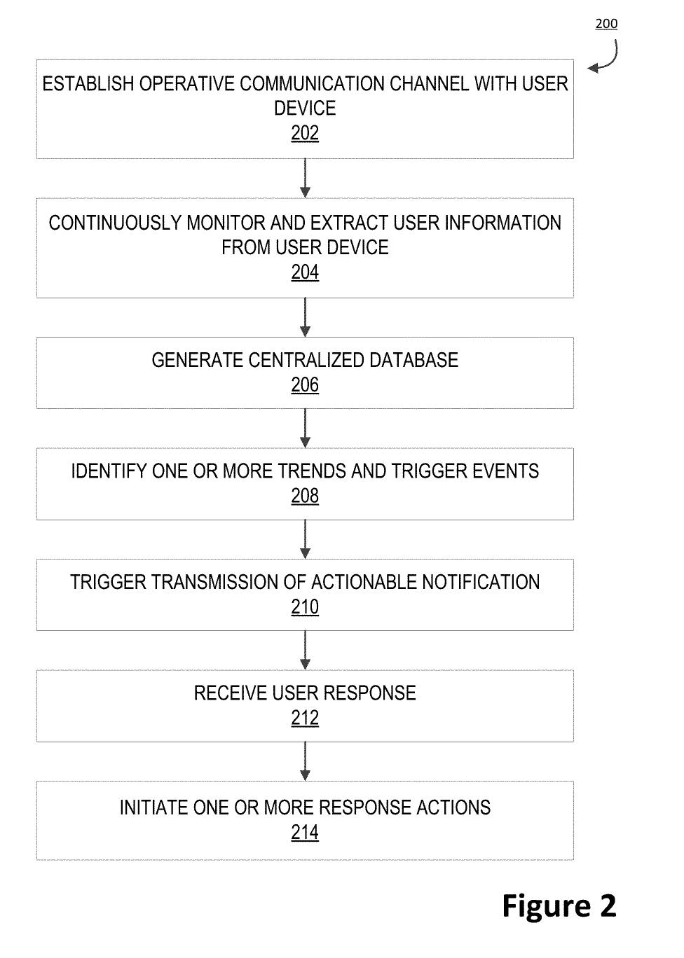

FIG. 2 illustrates a high level process flow for identifying and generating actionable notifications for small business operations 200, in accordance with one embodiment of the invention. As illustrated in block 202, the process 200 is initiated by first establishing an operative communication channel with the user device. The operable communication channel allows for data to be transmitted and received between the user coordination system 140 and the user device 111. In some embodiments, a control signal may be transmitted by the user coordination system to the user device causing the user device to display a notification to the user. In some embodiments, the user device is controlled by the user coordination system to display a graphical user interface which prompts the user to send a response back to the coordination system. In some embodiments of the invention, the user coordination system 140 may establish operative communication channels with one or more financial institution systems 160, third party systems 180, and/or other systems in order to transmit and receive information to and from the various other systems. In some embodiments, the established operative communication channel allows for communication in real-time between systems and devices. The user device may be a computing device associated with a user such as an owner of a small business, an employee of the small business, or the like. In some embodiments the system may establish an operative communication channel with a network of users via one or more user devices. For example, the system may establish an operative communication channel with the computing devices of all employers and/or employees across an entire business in order to coordinate activity and provide simultaneous updates for the business.

As illustrated in block 204 of FIG. 2, the coordination system continuously monitors and extracts user information on the user device. The user information that is monitored and extracted may include personal information associated with the user including financial data, device data, calendar data, social data, and the like. In other embodiments, the user coordination system may receive personal information and financial information such as financial account information and transaction history from a financial institution associated with the user. In some embodiments, the system may be maintained and operated by a financial institution. Device data extracted from the user device may include information associated with hardware and/or software usage such as an amount of time that the user has spent within a particular application or data associated with the application such as internet browsing data. In some embodiments, device data may include user communications transmitted and received from the device such as email, short message service (SMS), and the like.

In some embodiments, the system may monitor and extract calendar data from the user device over the communication channel. The system may extract appointments, meetings, reminders, scheduled events, and the like present in a calendar application on the user device. In some embodiments, the system may at least partially assist in populating a user's calendar based on user information extracted from other sources such as email. In some embodiments, the system may extract data from social media accounts associated with the user. This social media account data may be stored locally on the user device or stored on a third party system.

Monitoring of user information on the user device and/or on third party systems, via one or more established operable communication channels, may be continuous allowing for real-time updates as changes to the user information occur. For example, a user may add an appointment to his or her calendar allowing the system to extract this recently added event in real-time and provide up-to-date decisions, notifications, and actions based on the most recent information available on the user device.

In some embodiments, the system may request authorization and authentication from the user in order to access various information and data stored, transmitted, and/or received by the user device or on third party systems containing information associated with the user. For example, the system may request authorization from the user to access financial information contained in a user's checking account stored on a third party financial institution's system. In this example, the system may require the user to authenticate his or her identity and provide credentials or authentication information to access the account such as a username, password, and/or other user identifying information. In another example, the system may request authorization and user authentication to a social media account associated with the user by prompting the user, via a provided link, to sign in to the social media account.

In some embodiments, the system may continuously monitor conversations or group conversations conducted within email and chat applications. In some embodiments, the system may be integrated into the communication channels or applications allowing the system to monitor and extract information within conversations in real-time and provide additional information or notifications to the users associated with the conversation via the communication channel based on the monitored information extracted from the conversation. In this way, the system may generate and provide an email, text or SMS message, link, and/or the like to the users via the communication channel that the users are communicating over.

As illustrated in block 206 of FIG. 2, the system generates a centralized database containing the extracted user information. Aggregating and storing user information in the centralized database improves the functionality of the computer hardware by creating a single, comprehensive database in which to search and process user information which reduces the processing time and memory required by the system to retrieve and process stored information. In some embodiments, the system may convert or transform extracted user information into a format, such as a table, that may be efficiently stored and searched for within the centralized database in the system. In some embodiments the system may employ optical character recognition to transform information such as calendars, documents, images, and the like into a text format that may be identified and processed by the system for storing and subsequent use. In some embodiments, the system may employ optical character recognition to scan and transform physical documents such as a scanned, physical calendar into an electronic format that may be stored and processed within the centralized database.

As illustrated in block 208 of FIG. 2, the system identifies one or more trends and trigger events associated with the user. Trends may be habits of the user identified from the extracted user information stored in the database. In some embodiments, trends may be purchasing trends determined from a user's transaction history by extracting financial information or data from the user device or a financial institution associated with the user. In some embodiments, trends may be identified from calendar data. For example, the user may consistently schedule an event, appointment, meeting or the like at regular intervals on his or her calendar. In some embodiments, trends may be determined form the device data extracted from the user device such as by monitoring and analyzing the internet browsing habits and history of the user or identifying applications regularly used by the user. For example, the system may identify that the user uses a ride sharing application at the same time every day to arrange transportation. In some embodiments, data extracted from social media accounts associated with the user may be monitored and analyzed to identify trends as well.

Trigger events may be a deadline, a scheduled event, an alert, and the like associated with the user. In some embodiments, the system may identify deadlines from the extracted user information such as targeted completion dates for projects, cutoff dates for a submission, due dates for bills, and the like. In some embodiments, scheduled events may be appointments, meetings, and the like. In some embodiments, alerts may be associated with personal tasks, employee instructions from an employer, a sales or marketing lead, the stock of an item, a third party product or service, opportunities for user aggregation benefits, and the like.

In some embodiments, trigger events may further comprise an open enrollment period for employees to enroll in a healthcare plan provided by the small business or a third party. For example, an employee may receive an email associated with an open enrollment period for healthcare from an employer or third party healthcare provider. The system would extract this information from the received email on the employee's computing device and identify this open enrollment period as a trigger event.

In some embodiments, trigger events may be financial events or life events determined from the information extracted from the user device and accounts. For example, the system may identify from the extracted information that a user has recently received a raise, moved to a new house, had a new child, and the like.

In some embodiments of the invention, the system coordinates deadlines, meetings, activities, and the like for all employers and employees within a business, wherein changes to activities are automatically updated throughout the network and pushed to those user devices associated with the changed activity.

As illustrated in block 210 of FIG. 2, based on the identification of one or more trends and trigger events associated with the user, the system triggers the transmission of an actionable notification to the user device, wherein user action is required. The actionable notification may be associated with the one or more trends and trigger events identified from the extracted user information. In some embodiments, the user may interact with the notification, wherein the user is prompted to confirm or decline the notification. For example, the user may be prompted to accept or decline an invitation to a meeting. In other embodiments, the notification provides a link for the user to follow to perform further actions. For example, a notification may provide a link to the user to a website for a healthcare provider, wherein the user may enroll in a healthcare plan.

In some embodiments, the system may provide the user with recommendations for a user action based on the actions performed by other users or similarly situated users as determined from the extracted information. For example, the user may be presented with a notification informing the user of an open enrollment period for healthcare. In addition, the system may recommend a particular healthcare plan to the user based on the choices of other similarly situated users such as other employees or coworkers. In some embodiments, the system may identify the extent that the user is dissimilar to other similar situated users and based on the identified differences, recommend that the user perform different or additional actions tailored for the user. For example, the system may recommend to the user a health plan that a similarly situated user signed up for but then recommend additional coverage based on determining that the user would require specialized vision care.

In some embodiments, the system may transmit a notification containing a message from an employer to his or her employees. For example, an employer may send a notification to his or her employees reminding them to sign up for a health care plan, contribute to an IRA, or the like. Additionally, the notification from the employer may provide a link to the employees directing them to a website to sign up for a health plan, contribute to an IRA, or the like. In some embodiments, the notification provides a weblink or attachment to the user.

In some embodiments, the system may allow for users to send notifications containing leads, such as sales or maintenance tips, to other users within the system. In some embodiments, the system may automatically direct leads to appropriate users based on the extracted user information. For example, the system may direct a sales lead to a salesman, the system having identified the particular user as a salesman based on the contents of the user information extracted from the user device.

In some embodiments, the system may connect one or more users or teams of users within an organization, such as a business, who are or have been associated with the same or identical project, task, or the like in order to promote teamwork or provide pathways for communication and sharing of advice and expertise between users and/or teams.

In some embodiments, the system may connect, via the notification system, similarly situated users who wish to exchange professional or personal advice. For example, the system may identify from the extracted information that a user has just had a new child. The system may connect this user with a similarly situated user who has also recently had a child or has had a child in the past in order for the users to exchange advice or act as a support.

In some embodiments of the invention, the system may have access to the inventory associated with the user's business. For example, the user may be a small business owner who uses his or her user device to maintain inventory records and current stock of items within the small business. In this way, the system may monitor the inventory records on the user device and transmit an actionable notification to one or more users that stock of an item is low. In some embodiments, the system may ask the user for confirmation to replenish low stock of an item or provide a link to the user to replenish the low inventory by ordering more of the low stock item. In some embodiments, the user may set a predetermined threshold for triggering transmission of a notification, wherein the system will only transmit the notification when the number of an item in the inventory falls below the predetermined threshold.

As illustrated by block 212 of FIG. 2, the system receives the user response to the transmitted actionable notification. In some embodiments, the system transmits a control signal to the user device to cause it to display a graphical user interface allowing the user to respond to the actionable notification, wherein the user's response may be received by the system. In some embodiments, the actionable notification may provide the user with one or more selectable buttons or links to allow the user to respond to the notification, wherein the response is received by the system. In one example, the user is presented with a scheduled meeting for later in the week that was extracted from his or her email. The user confirms the email and this confirmation is received by the system.

As illustrated by block 214, the system initiates one or more response actions based on the user response received from the user device. The response action initiated by the system is based on the trend or trigger event identified by the system, the contents of the notification transmitted to the user, and the user response received by the system. In some embodiments, the system may update the user's device or calendar based on the user's response. For example, the system may update the user's calendar in response to the user confirming a meeting, appointment, or other scheduled event. In some embodiments, the system may generate and transmit a notification informing other users associated with the meeting, appointment, or other scheduled event that the user confirmed his or her attendance.

In some embodiments, the system may schedule reminders associated with a deadline for one or more users. In some embodiments, the system may generate a checklist of scheduled events, actions, and/or tasks for the one or more users to complete in order to meet the scheduled deadline and transmit the checklist to the one or more users via their associated devices. In some embodiments the checklist is provided by the one or more users. In another embodiment, the checklist is a predefined template.

In other embodiments, the system may identify one or more user aggregation benefits from the identified user trends and trigger events from multiple users. The system may identify multiple users with similar interests or trends and provide offers for product and/or services for the multiple users to take advantage of. The system may identify that a group of users require transportation to the same location and transmit a notification to the group of users which identifies the shared transportation request and the users within the group so that the group may arrange transportation together. In one example, the group of users may be coworkers who work at the same location and wish to carpool or share transportation. In some embodiments, the system may arrange for shared transportation for the group of users. In some embodiments, the system may establish an operative communication channel with a third party transportation provider and negotiate a group discount on behalf of the users.

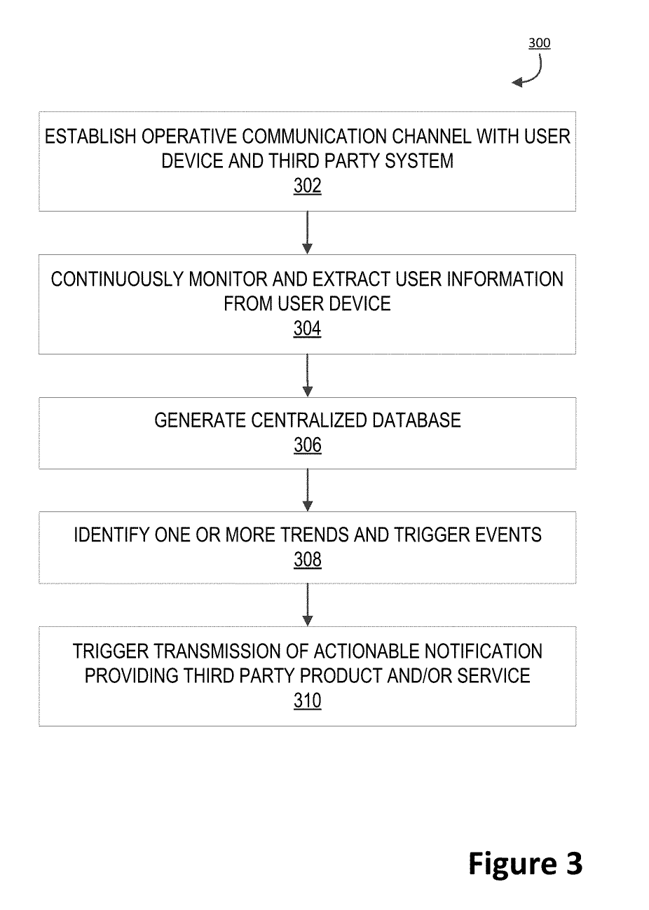

FIG. 3 illustrates a high level process flow for identifying and generating actionable notifications for providing third party products and/or services 300, in accordance with one embodiment of the invention. As illustrated in block 302, the process 300 is initiated by first establishing an operative communication channel with the user device and third party system. The operable communication channel allows for data to be transmitted and received between the user coordination system 140, the user device 111, and the third party system 180.

As illustrated in blocks 304, 306, and 308, the system continuously monitors and extracts user information from the user device, generates a centralized database, and identifies one or more trends and trigger events, respectively, as previously discussed, before triggering a transmission of an actionable notification providing a third party product and/or service to the user based on the identified user trends and trigger events. In some embodiments, the third party products and service are provided to the user by the system based on the user information extracted from the user device. In some embodiments, the system provides third party financial products and services such as offers to open banking accounts, invest in a retirement account, and the like. In some embodiments, the system provides non-financial third party products and services such as a concierge service for dry cleaning offered to employees or the like. In other embodiments, these products and service may be offered by the financial institution or business.

In some embodiments of the invention one or more of the systems described herein may be combined with each other, or otherwise perform the functions of the other systems described herein. In other embodiments of the invention one or more of the applications described herein may be combined with each other, or otherwise perform the functions of the other applications described herein. Furthermore, the applications may be any type of application, such as an application stored on a desktop, server, or other device, a mobile application stored on a mobile device, a cloud application, or other like application. As such, the applications described herein, or portions of the applications described herein may be stored and operated on any of the systems or devices described herein. For example, a portion of one or more applications may be stored on the user device, or may be included as a portion of financial institution applications, such as an online banking application, in order to achieve embodiments of the inventions described herein.

It should be understood, that the systems and devices described in FIG. 1, or other devices not specifically described herein, may be configured to establish a communication link with each other in order to accomplish the steps of the processes described herein. The link may be an internal link within the same entity (e.g., within the same financial institution or device provider) or a link with the other systems of entities (e.g., social networking systems, third-party systems, or the like). In some embodiments, the systems may be configured for monitoring the applications and devices that the system(s) utilize as data sources. The information received from monitoring may be provided via wireless network path portions through the Internet. When the systems or devices are not monitoring a source or are not being monitoring, the information need not be transmitted from the source through the Internet to the destination, although it could be. The sources of information may be made continuously available, however, continuously available does not necessarily mean that the sources actually continuously generates data, but that a source is continuously available to generate and send data real-time (e.g., instantaneously and/or within a few seconds, or the like) of receiving a request for it. In any case, the sources may be continuously available to receive and/or generate information, in some cases in digitized data in Internet Protocol (IP) packet format. In response to continuously monitoring the real-time data feeds from the various systems or devices, the system may be configured to provide target information to the user and/or allow the user to make changes to or control the applications and/or devices.

Moreover, it should be understood that the process flows described herein include transforming the information sent and/or received from the applications of the different systems (e.g., internally or externally) and/or the devices from one or more data formats into a data format associated with an application for display to the user on the user device. There are many ways in which information is converted within the system environment. This may be seamless, as in the case of upgrading to a newer version of a computer program. Alternatively, the conversion may require processing by the use of a special conversion program, or it may involve a complex process of going through intermediary stages, or involving complex “exporting” and “importing” procedures, which may converting to and from a tab-delimited or comma-separated text file. In some cases, a program may recognize several data file formats at the data input stage and then is also capable of storing the output data in a number of different formats. Such a program may be used to convert a file format. If the source format or target format is not recognized, then at times a third program may be available which permits the conversion to an intermediate format, which can then be reformatted.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for identifying and generating actionable notifications for user coordination, the system comprising:
at least one memory device;
at least one communication device connected to a distributed network;
at least one processing device operatively coupled to the at least one memory device and the at least one communication device; and
a module stored in the at least one memory device comprising executable instructions that when executed by the at least one processing device, cause the at least one processing device to:
establish, via the distributed network, an operative communication channel with a user device associated with a user, wherein the operative communication channel allows for real-time communication with the user device;
monitor, continuously, and extract user information from the user device via the operative communication channel, wherein extracted user information comprises financial data, device data, calendar data, and social data;
generate a database containing the extracted user information;
identify one or more trends and trigger events associated with the user, the one or more trigger events comprising a deadline, a scheduled event, or an alert;
trigger transmission of an actionable notification to the user device, wherein the actionable notification is associated with the one or more trends and trigger events;
receive a user response associated with the actionable notification; and
initiate one or more response actions based on the received user response.

2. The system of claim 1, wherein establishing the operative communication channel with the user device further comprises establishing an operative communication channel with a third party system, wherein third party products and services are provided to the user based on the user information extracted from the user device.

3. The system of claim 1, wherein initiating one or more response actions based on the received user response further comprises updating a calendar on the user device with the one or more trigger events based on receiving a confirmation in the user response associated with the actionable notification.

4. The system of claim 1, wherein initiating one or more response actions based on the received user response further comprises generating a checklist of scheduled events and actions for the user to complete in order to meet a scheduled deadline.

5. The system of claim 1, wherein continuously monitoring and extracting user information from the user device via the operative communication channel further comprises monitoring a number of an item in an inventory and transmitting an actionable notification to the user device based on determining that the number of an item in the inventory has fallen below a predetermined threshold.

6. The system of claim 1, wherein identifying the one or more trends and trigger events associated with the user further comprises determining purchasing trends associated with the user from the financial data stored on the user device and/or a financial institution associated with the user.

7. The system of claim 1, wherein identifying the one or more trends and trigger events associated with the user further comprises monitoring the user's internet browsing history, social media activity, and frequently used applications on the user device.

8. A computer program product for identifying and generating actionable notifications for user coordination, the computer program product comprising at least one non-transitory computer readable medium having computer-readable program code portions embodied therein, the computer-readable program code portions comprising:
an executable portion configured for establishing, via the distributed network, an operative communication channel with a user device associated with a user, wherein the operative communication channel allows for real-time communication with the user device;
an executable portion configured for continuously monitoring and extracting user information from the user device via the operative communication channel, wherein extracted user information comprises financial data, device data, calendar data, and social data;
an executable portion configured for generating a database containing the extracted user information;
an executable portion configured for identifying one or more trends and trigger events associated with the user, the one or more trigger events comprising a deadline, a scheduled event, or an alert;
an executable portion configured for triggering transmission of an actionable notification to the user device, wherein the actionable notification is associated with the one or more trends and trigger events;
an executable portion configured for receiving a user response associated with the actionable notification; and
an executable portion configured for initiating one or more response actions based on the received user response.

9. The computer program product of claim 8, wherein establishing the operative communication channel with the user device further comprises establishing an operative communication channel with a third party system, wherein third party products and services are provided to the user based on the user information extracted from the user device.

10. The computer program product of claim 8, wherein initiating one or more response actions based on the received user response further comprises updating a calendar on the user device with the one or more trigger events based on receiving a confirmation in the user response associated with the actionable notification.

11. The computer program product of claim 8, wherein initiating one or more response actions based on the received user response further comprises generating a checklist of scheduled events and actions for the user to complete in order to meet a scheduled deadline.

12. The computer program product of claim 8, wherein continuously monitoring and extracting user information from the user device via the operative communication channel further comprises monitoring a number of an item in an inventory and transmitting an actionable notification to the user device based on determining that the number of an item in the inventory has fallen below a predetermined threshold.

13. The computer program product of claim 8, wherein identifying the one or more trends and trigger events associated with the user further comprises determining purchasing trends associated with the user from the financial data stored on the user device and/or a financial institution associated with the user.

14. The computer program product of claim 8, wherein identifying the one or more trends and trigger events associated with the user further comprises monitoring the user's internet browsing history, social media activity, and frequently used applications on the user device.

15. A computer-implemented method for identifying and generating actionable notifications for user coordination, the method comprising:
providing a control device and control device housing comprising computing system comprising a computer processing device and a non-transitory computer readable medium, where the computer readable medium comprises configured computer program instruction code, such that when said instruction code is operated by said computer processing device, said computer processing device performs the following operations:
establishing, via the distributed network, an operative communication channel with a user device associated with a user, wherein the operative communication channel allows for real-time communication with the user device;
monitoring, continuously, and extracting user information from the user device via the operative communication channel, wherein extracted user information comprises financial data, device data, calendar data, and social data;
generating a database containing the extracted user information;
identifying one or more trends and trigger events associated with the user, the one or more trigger events comprising a deadline, a scheduled event, or an alert;
triggering transmission of an actionable notification to the user device, wherein the actionable notification is associated with the one or more trends and trigger events;
receiving a user response associated with the actionable notification; and
initiating one or more response actions based on the received user response.

16. The computer-implemented method of claim 15, wherein establishing the operative communication channel with the user device further comprises establishing an operative communication channel with a third party system, wherein third party products and services are provided to the user based on the user information extracted from the user device.

17. The computer-implemented method of claim 15, wherein initiating one or more response actions based on the received user response further comprises updating a calendar on the user device with the one or more trigger events based on receiving a confirmation in the user response associated with the actionable notification.

18. The computer-implemented method of claim 15, wherein initiating one or more response actions based on the received user response further comprises generating a checklist of scheduled events and actions for the user to complete in order to meet a scheduled deadline.

19. The computer-implemented method of claim 15, wherein continuously monitoring and extracting user information from the user device via the operative communication channel further comprises monitoring a number of an item in an inventory and transmitting an actionable notification to the user device based on determining that the number of an item in the inventory has fallen below a predetermined threshold.

20. The computer-implemented method of claim 15, wherein identifying the one or more trends and trigger events associated with the user further comprises determining purchasing trends associated with the user from the financial data stored on the user device and/or a financial institution associated with the user.
